(19) United States
(12) Patent Application Publication
(10) Pub. No.: US 2020/0164401 A1
(43) Pub. Date: May 28, 2020

(54) APPARATUS, METHOD OF MAKING A POWDER-RUBBED SUBSTRATE, AND POWDER-RUBBED SUBSTRATE

(71) Applicant: 3M INNOVATIVE PROPERTIES COMPANY, St. Paul, MN (US)

(72) Inventors: James N. Dobbs, Woodbury, MN (US); Karl K. Stensvad, Inver Grover Heights, MN (US); Eric A. Vandre, Roseville, MN (US); Daniel H. Carlson, Arden Hills, MN (US); Ranjith Divigalpitiya, London (CA); Gerrard A. S. Marra, Arva (CA); Saurabh Batra, Minneapolis, MN (US); Satinder K. Nayar, Woodbury, MN (US); Verlin W. Schelhaas, New Richmond, WI (US); Chrispian E. Shelton, Minneapolis, MN (US); Samad Javid, Woodbury, MN (US)

(21) Appl. No.: 16/635,331

(22) PCT Filed: Jul. 24, 2018
(86) PCT No.: PCT/IB2018/055513

§ 371 Date: Jan. 30, 2020

Related U.S. Application Data
(60) Provisional application No. 62/539,708, filed on Aug. 1, 2017.

(51) Int. Cl. B05C 19/04; B05C 1/12; B05D 1/28; B05C 5/02; B05C 1/08

(52) U.S. Cl. CPC B05C 19/04; B05C 1/12; B05D 2201/02; B05C 5/0295; B05C 1/0843; B05D 1/28

(57) ABSTRACT

A powder-rubbing apparatus comprises: a rotatable rubbing roll having a rotational axis; a substrate path; an oscillating mechanism for oscillating the rotatable rubbing roll along the rotational axis; and a powder coating die comprising an inlet port in fluid communication with an outlet port disposed adjacent to the substrate path. The substrate frictionally contacts the rotatable rubbing roll within a rubbing zone. A dispenser for dispensing gas-borne powder is in fluid communication with the inlet port of the powder coating die. The dispenser is aligned such that at least a portion of a gas-borne powder dispensed from the powder coating die is deposited directly onto at least one of the rotatable rubbing roll or the substrate and conveyed into the rubbing zone. A method of using the powder-rubbing apparatus and a powder-rubbed web preparable thereby are also disclosed.

### TECHNICAL FIELD

The present disclosure relates to powder-rubbing apparatus, method of coating a powder onto a substrate to form a powder-rubbed substrate, and powder-rubbed substrates made thereby.

### BACKGROUND

Various methods of bonding powders to substrates (e.g., plastic film) in the form of a thin adherent coating have been known for many years. In one technique, the powder is applied to the surface of the substrate and rubbed until it becomes adherent. This general coating technique is hereinafter referred to as “powder-rubbing”.

One such powder-rubbing method is described in U.S. Pat. No. 6,511,701 B1 (Divigalpitiya et al.). In it random orbital rubbing machines were used to powder-rub various soft powders onto a substrate surface. While a drill-powered paint roller loaded with powder was also used, it gave poor quality coatings. However, the method has practical limitations with respective to manufacturing speed.

U.S. Pat. No. 4,741,918 (Nagybaczon et al.) describes a method of coating dry discrete particles onto the surface of a substrate using a soft, resilient rubbing wheel. Certain organic polymers, metals, metal oxides, minerals, diamond, china clay, pigments, and metalloid elements are disclosed as suitable materials for the coating method.

There remains a need for improved methods (e.g., faster and/or more uniform) for powder-rubbing powders onto substrates.

### SUMMARY

Advantageously, the present disclosure provides rapid methods of powder-rubbing powders onto substrates that result in powder-rubbed substrates with improved physical properties of the powder-rubbed layer.

In one aspect, the present disclosure provides a powder-rubbing apparatus suitable for making a powder-rubbed substrate, the powder-rubbing apparatus comprising:

a rotatable rubbing roll having a rotational axis;

a substrate path for conveying the substrate in a machine direction into frictional contact with the rotatable rubbing roll within a rubbing zone, wherein the substrate frictionally contacts the rotatable rubbing roll within the rubbing zone;

an oscillating mechanism for oscillating the rotatable rubbing roll along the rotational axis;

a powder coating die comprising an inlet port in fluid communication with an outlet port, wherein the powder coating die is disposed adjacent to the substrate path; and

a dispenser for dispensing gas-borne powder in fluid communication with the inlet port of the powder coating die, wherein the dispenser is aligned such that at least a portion of a gas-borne powder dispensed from the powder coating die is deposited directly onto at least one of the rotatable rubbing roll or the substrate and conveyed into the rubbing zone.

In another aspect, the present disclosure provides a method of making a powder-rubbed substrate, the method comprising:

providing a powder-rubbing apparatus according to the present disclosure, wherein the rotatable rubbing roll is rotating, and wherein the rotatable rubbing roll is oscillating along its rotational axis;

disposing a substrate along the substrate path;

advancing the substrate in the machine direction at a differential rate relative to the rotatable rubbing roll; and

delivering the gas-borne powder from the outlet port onto at least one of the rotatable rubbing roll or the substrate, wherein at least some of the powder is rubbed onto the substrate as the substrate and the rotatable rubbing roll contact each other, thereby providing the powder-rubbed substrate.

In yet another aspect, the present disclosure provides a powder-rubbed substrate made according to the method of the present disclosure.

Advantageously, the powder-rubbing apparatus according to the present disclosure and the method of using it result in a powder-rubbed substrate with good uniformity and, in the case of conductive powders (e.g., thermally conductive and/or electrically conductive), improved conductivity. It may also reduce defects (e.g., streaking) and/or reduce process sensitivity to contaminants.

As used herein:

the term “powder” refers to loosely associated substantially dry fine particles; and

the term “vacuum source” refers to a source (e.g., an aspirator or vacuum pump) of reduced pressure relative to the ambient pressure.

Features and advantages of the present disclosure will be further understood upon consideration of the detailed description as well as the appended claims.

### BRIEF DESCRIPTION OF THE DRAWINGS

FIG. 1 is a schematic depiction of an exemplary method 100a of making a powder-rubbed substrate 300 using powder-rubbing apparatus 200.

FIG. 2 is a schematic depiction of an exemplary method 100b of making a powder-rubbed substrate 300 using powder-rubbing apparatus 200 equipped with optional housing 165 with vacuum port 167.

FIG. 3 is a schematic side view of rotatable rubbing roll 110 and oscillating mechanism 122.

FIG. 3A is a schematic end view of rotatable rubbing roll 110.

FIG. 4 is a schematic perspective view of an exemplary rubbing process showing the resultant sinusoidal rubbing path of an oscillating rotating rubbing roll 110 during use.

FIG. 5 is a schematic perspective view of powder coating die 130.

FIG. 6 is a schematic perspective view of an exemplary powder deagglomerator 1100.

FIG. 7 is a schematic top view of a powder deagglomerator 1100.

FIG. 8 is a schematic cross-sectional side view of powder deagglomerator 1100 in FIG. 7 taken along line 8-8.

FIG. 9 is a schematic bottom view of vertical flow chamber 1110 and associated powder inlet tube 1150.

FIG. 10A is a schematic side view of an agglomerated powder 1190.

FIG. 10B is a schematic side view of unagglomerated constituent particles 1195.

FIG. 11 is a schematic process flow diagram illustrating powder deagglomerator 1100 in operation.

FIG. 12 is a perspective drawing of exemplary powder jet pump 2020.

FIG. 13 is side cross section view of powder jet pump 2020, taken along section lines 13-13 in FIG. 12.

FIG. 14A is an enlarged view of region 14A in FIG. 13.

FIG. 14B is an enlarged perspective cross-sectional view of region 14B in FIG. 13.

FIG. 15 is a side view of powder jet pump 2020.

FIG. 16 is a digital photograph of the buff coated film of Comparative Example A.

FIG. 17 is a digital photograph of the buff coated film of Example 1.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

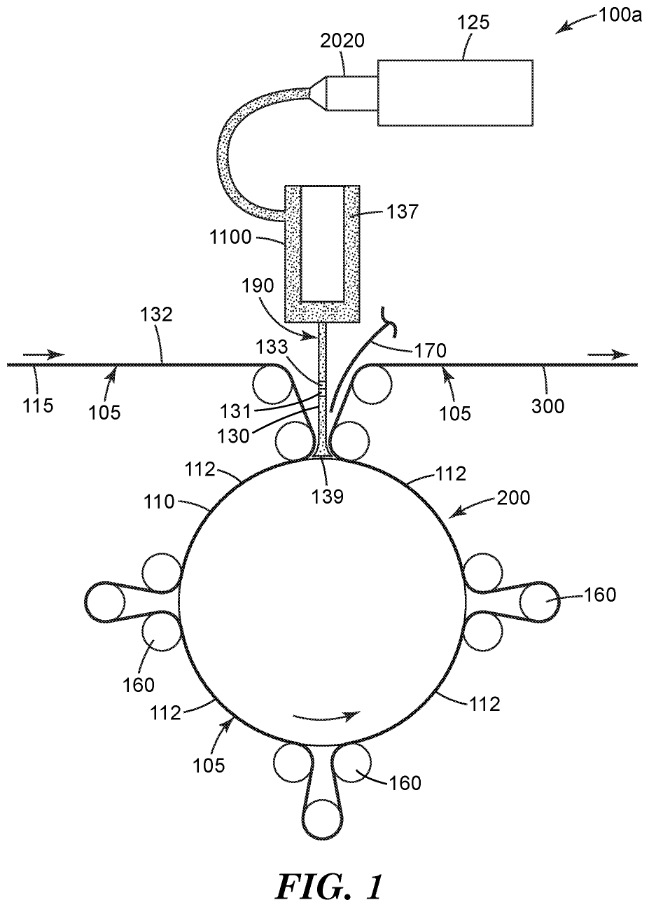

Referring now to FIG. 1, powder-rubbing apparatus 200 comprises rotatable rubbing roll 110, powder source 125, powder coating die 130, dispenser 190 for supplying gas-borne powder to powder coating die 130, and assorted optional web handling rollers 160 that direct substrate 115 along a substrate path 105 through rubbing zones 112. Powder coating die 130 comprises an inlet port 131 in fluid communication with outlet port 139 disposed adjacent to the substrate path 105. Outlet port 133 of dispenser 190 is fluidly connected to inlet port 131. Optional vacuum collector 170, which is fluidly connected to a first vacuum source (not shown), removes any excess powder from rotatable rubbing roll 110. Powder coating die 130 dispenses powder 137 onto rotatable rubbing roll 110. As shown, dispenser 190 includes optional powder deagglomerator 1100 and optional powder jet pump 2020, which is fed by powder extruder 125.

Substrate path 105 conveys substrate 115 in a machine direction into frictional contact with the rotatable rubbing roll 110 within rubbing zones 112. Powder coating die 130 is disposed adjacent to rotatable rubbing roll 110 outside rubbing zones 112, and is adapted such that gas-borne powder dispensed from the powder coating die is carried by the rotatable rubbing roll into the rubbing zones 112, later emerging as powder-rubbed substrate 300.

As surface 132 of substrate 115 contacts the powder coated rotatable rubbing roll, it is powder-rubbed onto the substrate to form an adherent coating of powder-rubbed layer on the surface of the substrate. In order to achieve rubbing action, the circumferential speed of the rubbing roll should be substantially different than the speed of the substrate as it passes through the powder-rubbing apparatus. For example, the circumferential speed may be at least 2 times, at least 3 times, at least 5 times, at least 10 times, at least 20 times, or even at least 50 times the line speed of the substrate. Preferably, the rotatable roll rotates in the same direction as the motion of the substrate, although this is not a requirement.

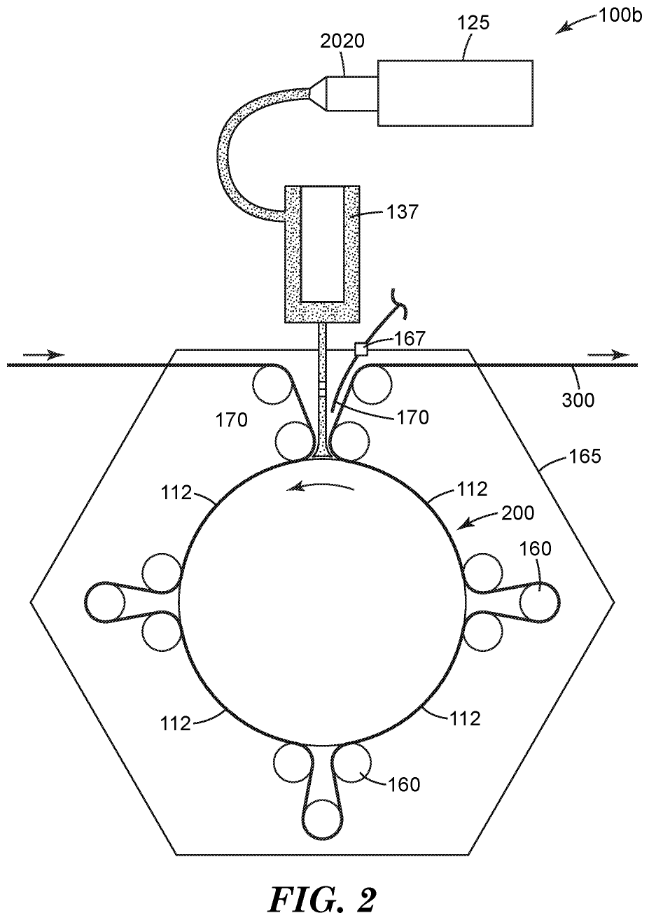

Referring now to FIG. 2, optional housing 165 controls powder contamination of the surrounding area and assists optional vacuum collector 170. Optional housing 165 contains optional vacuum port 167 that is fluidly connected to a vacuum source (not shown).

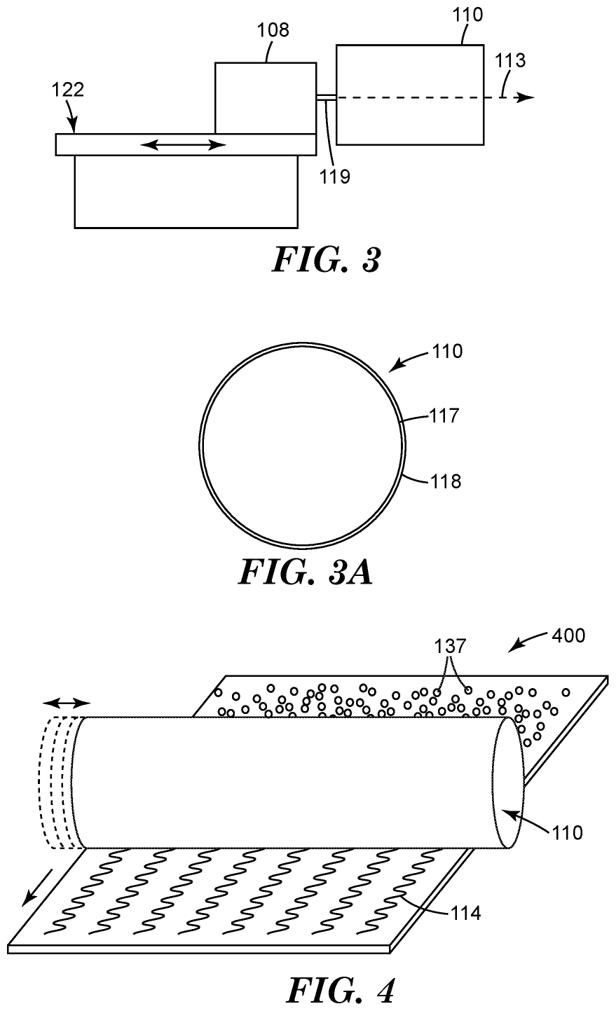

Referring now to FIG. 3, rotatable rubbing roll 110 engages shaft 119 which is disposed along rotational axis 113. Shaft 119 connects drive motor 108 to rotatable rubbing roll 110. Oscillating mechanism 122 (show as a shaker table) oscillates motor 108, shaft 119, and rotatable rubbing roll 110 along rotational axis 113. Preferably, rotational axis 113 is perpendicular to the machine direction (i.e., the direction of travel of the substrate along the substrate path); however, it may be oriented at any angle other that the machine direction. Alternatively, in some embodiments, rotatable rubbing roll 110 may be independently oscillated along shaft 119 without the requirement to oscillate drive motor 108.

Referring now to FIG. 3A, rotatable rubbing roll 110 has core 117 and optional resilient sleeve 118. In some embodiments, the sleeve is a flocked, napped, and/or nonwoven material such as that used for applying paint. During powder-rubbed coating, the substrate is wrapped around rotatable rubbing roll 110 with the substrate surface in contact with resilient sleeve 118. Through this contact, and the associate differential motion of the rotatable rubbing roll 110 and the substrate, the powder is powder-rubbed onto the surface of the substrate during operation.

The rotatable rubbing roll 110 may be made of any material, preferably a resilient material. In some preferred embodiments, the rotatable rubbing roll has a porous (e.g., an air permeable) outer sleeve 118 that may help to retain powder to be transferred during rubbing. In some preferred embodiments, the outer sleeve comprises at least one of a paint roller sleeve (e.g., a flocked or napped paint roller sleeve), a fabric sleeve, or a foam sleeve.

Referring now to FIG. 4, the oscillation of rotatable rubbing roll 110 results in formation of an oscillatory rubbing track 114 during powder-rubbing of powder. Preferably, the oscillation rate is from 2 to 25 hertz (Hz), more preferably 5 to 15 Hz, and even more preferably about 9 to 11 Hz for a substrate speed of from 1 to 70 meters/minute (m/min), preferably 3 to 35 m/min, although this is not a requirement. Preferably, the oscillation amplitude is from 1 to 20 millimeters (mm), more preferably 5 to 15 mm, and even more preferably 9 to 11 mm, although again this is not a requirement. Typically, higher rotary rubbing speeds are used at higher substrate speed.

Various mechanisms suitable for oscillating the rotatable rubbing roll are known in the art and/or will be apparent to those of ordinary skill in the art. In one embodiment, the rotatable rubbing roll is mounted to the drive shaft of a motor mounted to the oscillating bed of a shaker table. Since the substrate being coated is not supported by the shaker table, the rotatable rubbing roll oscillates transversely with respect to the substrate path. Additional examples include those disclosed in U.S. Pat. No. 3,032,931 (Eversole), U.S. Pat. No. 3,110,253 (Du Bois), U.S. Pat. No. 3,771,701 (Brunk et al.), U.S. Pat. No. 4,351,082 (Ackerman), U.S. Pat. No. 4,763,852 (Smith), U.S. Pat. No. 4,785,514 (Kannwischer), and U.S. Pat. No. 5,351,614 (Depa).

Dispenser 190 for dispensing gas-borne powder is in fluid communication with the inlet port 131 of the powder coating die 130 (see FIG. 1). The powder coating die is preferably aligned such that at least a portion of gas-borne powder dispensed from the powder coating die is deposited directly onto at least one of the rotatable rubbing roll or the substrate such that the particles are conveyed into the rubbing zone.

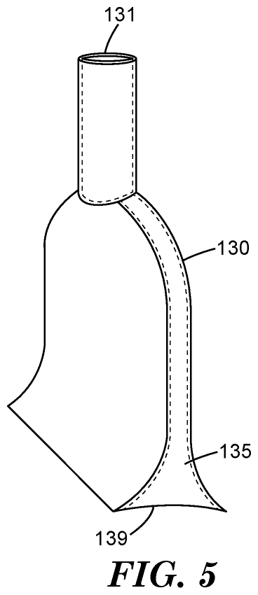

Referring now to FIG. 5, powder coating die 130 has interior die cavity 135 connecting inlet port 131 and elongate outlet port 139. Preferably, the outlet port of the powder coating die is spaced a distance of 300 mils (7.6 mm) or less from the rotatable rubbing roll, although other distances may also be used.

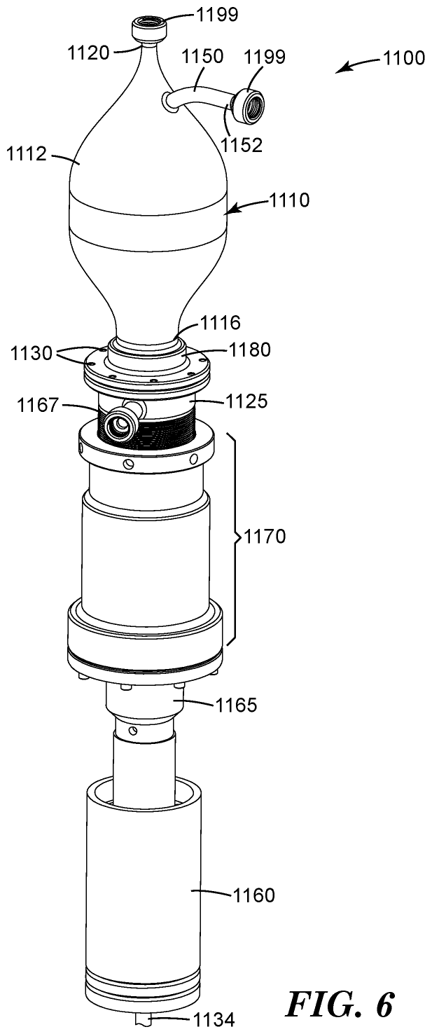

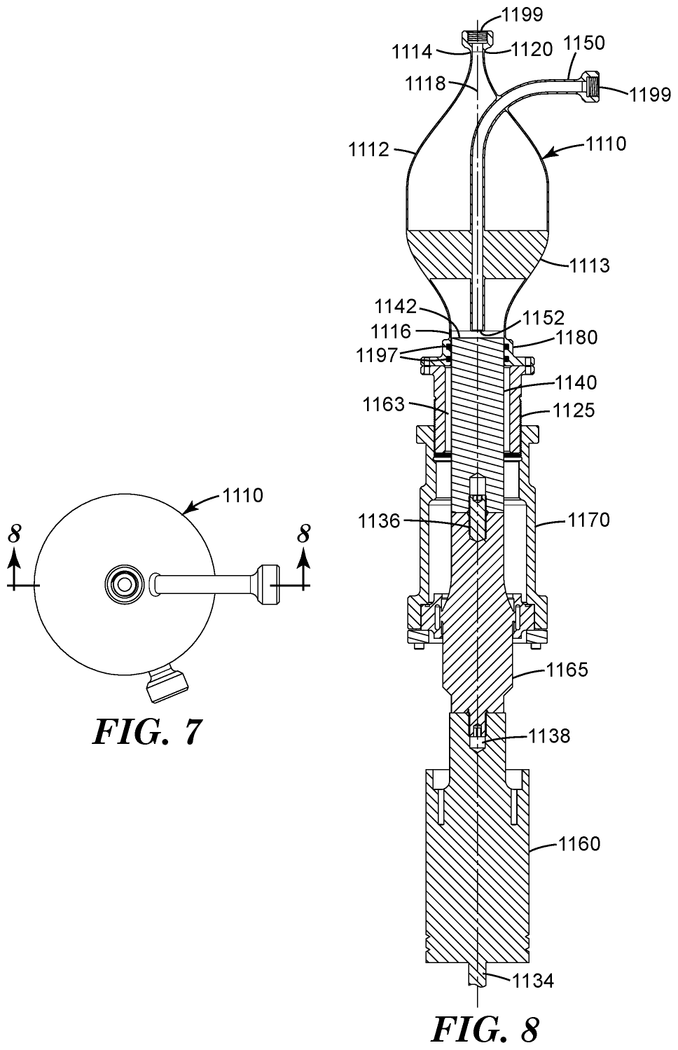

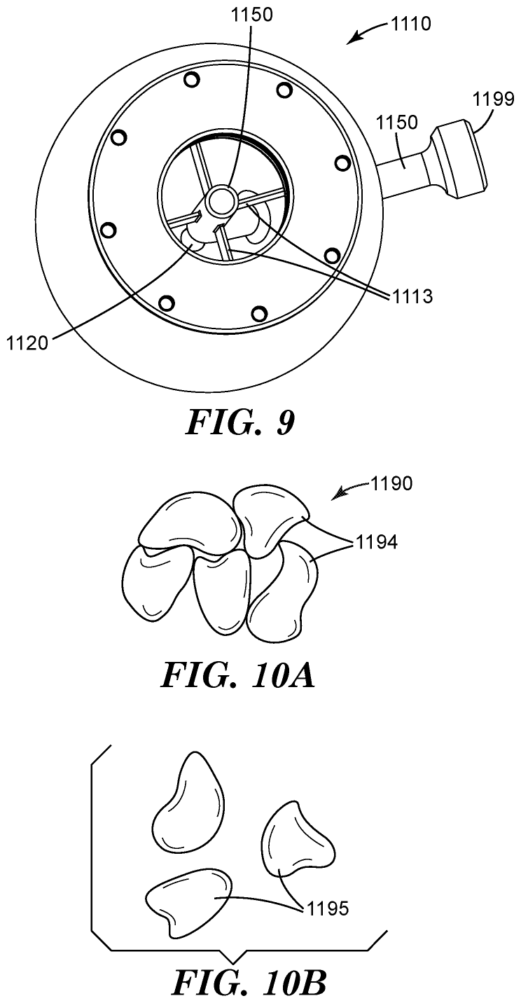

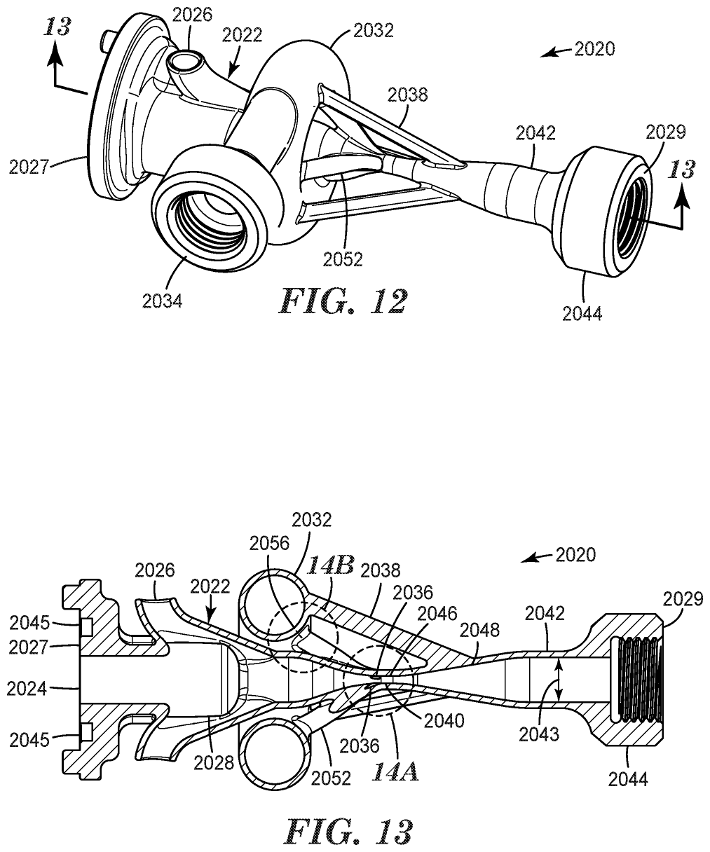

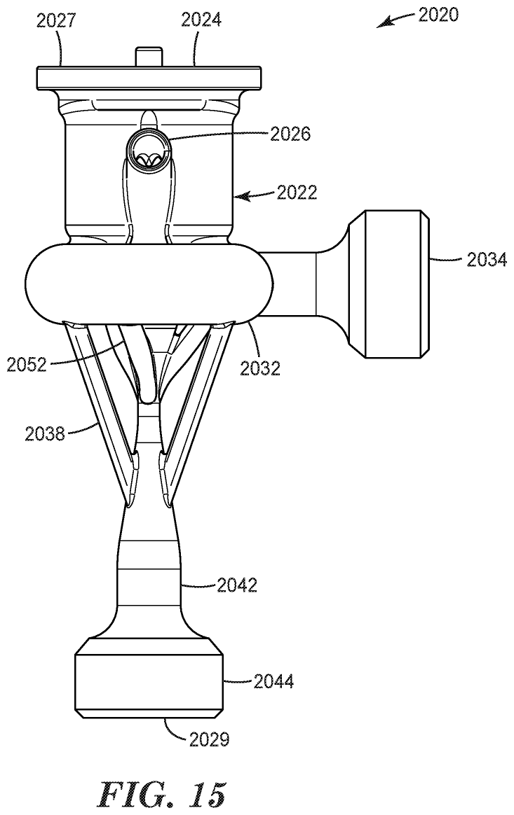

Referring now to FIG. 6-9, in some preferred embodiments, the dispenser comprises powder deagglomerator 1100 preferably disposed downstream from optional powder jet pump 2020 (see FIGS. 12-15), fed by powder extruder 125 (see FIG. 1).

Referring again to FIGS. 6-9, powder deagglomerator 1100 comprises hollow vertical flow chamber 1110 which has longitudinal axis 1118. Vertical flow chamber 1110 comprises outer wall 1112 with upper and lower ends 1114, 1116. Powder outlet port 1120 is disposed at upper end 1114. Mounting port 1180 sealably engages acoustic horn 1140 disposed at lower end 1116 of vertical flow chamber 1110. Optional pressure housing 1125 is secured to the mounting port 1180 such that acoustic horn 1140 extends within pressure housing 1125. Tubular housing adapter 1170 engages pressure housing 1125 and booster 1165.

End 1152 of powder inlet tube 1150 is disposed along longitudinal axis 1118 of vertical flow chamber. Upper and lower ends of the vertical flow chamber 1110 are inwardly tapered toward longitudinal axis. Acoustic horn 1140 has a cylindrical distal end 1142 vertically disposed within the vertical flow chamber 1110. Powder inlet tube 1150 extends through the outer wall 1112 and is supported by optional support fins 1113. Powder inlet tube 1150 is aligned to dispense agglomerated powder in a gaseous stream downward onto distal end 1142 of acoustic horn 1140. Acoustic transducer 1160 is vibrationally coupled to acoustic horn 1140 via booster 1165 which extends into optional pressure housing 1125. In use, electrical power cord 1134 supplies electrical energy to acoustic transducer 1160 from a power supply (not shown).

When electronically driven by an acoustic generator the transducer provides acoustic vibration to the booster and ultimately the acoustic horn. Acoustic generators, transducers, boosters, and horns of many suitable configurations are widely commercially available. Selection of appropriate acoustic transducers and generators is within the capability of those skilled in the art. The acoustic horn may be driven at a vibrational frequency of 1 kilohertz (kHz) to 1 megahertz (MHz), preferably 10 to 80 kHz, more preferably 10-50 kHz, and even more preferably 15-45 kHz, although other frequencies may also be used. Typically, the peak-to-peak displacement amplitude of the acoustic horn is in the range 0.25 microns to 7 mils (0.18 mm), preferably 1 micron to 3 mils (0.08 mm), although this is not a requirement. In some embodiments, the acoustic horn is an ultrasonic horn.

While vertical flow chamber is shown as being symmetrically rotatable around the longitudinal axis (e.g., as shown in FIG. 8), this is not a requirement, and other configurations are also possible. Likewise, one or both of the ends of the vertical flow chamber 1110 need not be tapered, although it is preferred. The vertical flow chamber 1110 need not be perfectly vertically oriented, but it is preferably within 20 degrees, more preferably within 10 degrees, and even more preferably within 5 degrees of vertical in order that, on a rotational basis around the longitudinal axis, an even distribution of powder within the vertical flow chamber is achieved.

Sealing members 1197 shown as elastomeric O-rings form seals between the tubular mounting member and the acoustic horn that aid in vibration damping and retention of the powder within the vertical flow chamber. Likewise, and threaded couplings 1199 form seals between inlet tube and powder outlet port with adjacent equipment (e.g., tubing, not shown). Sealing members 1197 serve to seal the chamber surrounding the radial face of the acoustic horn 1140 from the powder chamber. Optional air inlet port 1167 (shown in FIG. 6) permits chamber 1163 inside pressure housing 1125 to be slightly pressurized relative to the vertical flow chamber, if desired, to further reduce leakage of powder past the sealing members 1197.

The various parts of powder deagglomerator 1100 are fastened together using screws 1130, threaded boss 1138, and set screw 1136.

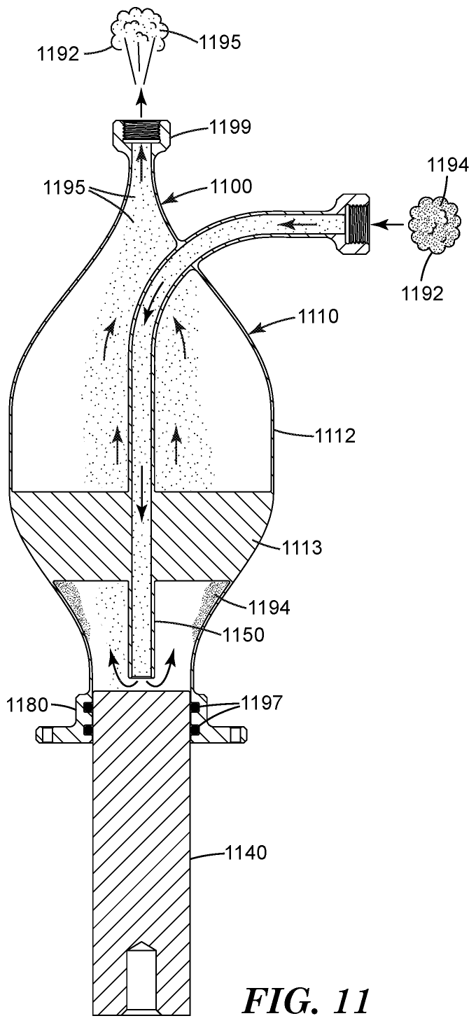

The acoustic powder deagglomerator shown in FIGS. 6-9 is shown in operation in FIG. 11. Agglomerated powder (1190) comprising agglomerated constituent particles 1194 entrained in gaseous stream 1192 (see FIG. 10A) is introduced through powder inlet tube 1150 downward onto distal end 1142 of acoustic horn 1140. Vibrational energy from the horn causes the agglomerated constituent particles to deagglomerate (see FIG. 10B) and preferentially rise within the vertical flow chamber, with the gaseous stream flow carrying the particles toward the powder outlet port 1199, while gravity tends to keep the larger agglomerated particles 1194 in the vicinity of the acoustic horn until they are eventually deagglomerated.

Preferably, the gaseous stream flow is adjusted such that at least 20, at least 30, at least 40, at least 50, at least 60, at least 70, at least 80, at least 90, or even at least 95 percent of the agglomerated particles are deagglomerated during one pass through the powder deagglomerator, although this is not requirement. The flow will necessarily depend upon the average constituent particle diameter and the size of the powder deagglomerator. For any given size of powder deagglomerator, lower gaseous stream flow is generally used with smaller average particle diameters, and conversely higher gaseous stream flow is generally used with larger average particle diameters.

Suitable powders include powders comprising graphite, clays, hexagonal boron nitride, pigments, inorganic oxides (e.g., alumina, calcia, silica, ceria, zinc oxide, or titania), metal(s), organic polymeric particles (e.g., polytetrafluoroethylene, polyvinylidene difluoride), dry biological powders (e.g., spores, bacteria). Preferably, unagglomerated constituent particles prepared according to the present disclosure are used promptly after deagglomeration in order to prevent reagglomeration.

Preferably, the constituent particles have an average particle size of 0.1 to 100 microns, more preferably 1 to 50 microns, and more preferably 1 to 25 microns, although this is not a requirement. To ensure that the powder particles contact the acoustic horn, the gap between the powder inlet tube and the distal end of the acoustic horn face is preferably set at a gap of 30 to 250 mils (0.76 to 6.35 mm), although this is not a requirement. One skilled in the art can observe that the gap is many times greater than the particle and agglomerate size and thereby doesn't serve as a physical barrier to the flow of the powder.

The vertical flow chamber, tubing, and associated components can be made of any suitable material such as, for example, metal, thermoplastic, and/or cured polymeric resin. In preferred embodiments, the vertical flow chamber is fabricated by 3D printing.

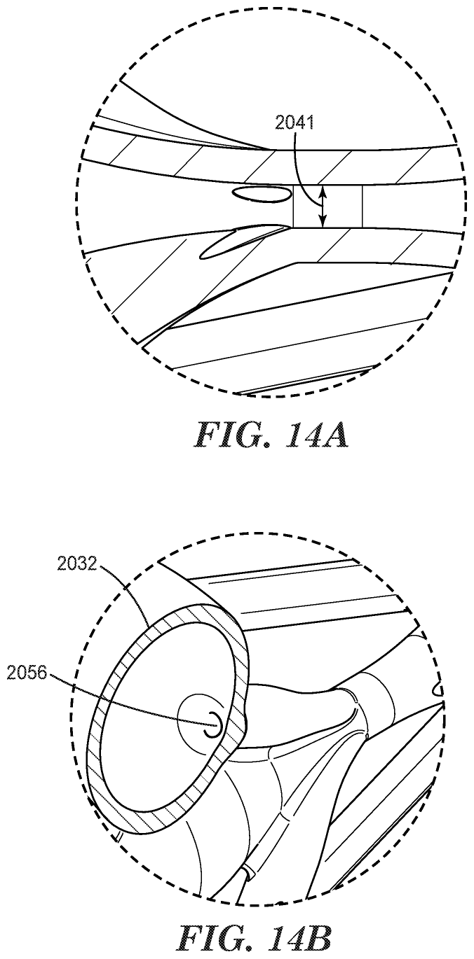

Referring now to FIGS. 12-15, optional powder jet pump 2020 comprises a main body 2022 having a particle inlet 2024 at a first end 2027 and an outlet connector 2044 at a second end 2029. Particle inlet 2024 is in fluid communication with inlet chamber 2028. Nozzle 2042 defines passage 2048 in fluid communication with inlet chamber 2028 and outlet connector 2044. Nozzle 2042 includes nozzle throat 2040. Suction inlets 2026 are in fluid communication with inlet chamber 2028. Annular plenum 2032, positioned around main body 2022, has gas inlet 2034. While shown as a torus, it will be recognized that other shapes of the annular plenum that accomplish the technical effect of feeding the jet passages may also be used (e.g., polygonal plenums). Hollow jet passages 2052 each have a respective inlet opening 2056 (see FIG. 14B) into annular plenum 2032 and an outlet opening 2036 within nozzle throat 2040. Optional braces 2038 add structural reinforcement to powder jet pump 2020.

In use, pressurized gas (e.g., compressed air) enters gas inlet 2034, continues into annular plenum 2032, and is directed through jet passages 2052 from annular plenum 2032 to nozzle throat 2040 positioned at the end of inlet chamber 2028 opposite particle inlet 2024. Throat 2040 widens into nozzle 2042, terminating in outlet connector 2044. Exemplary useful gases include air, nitrogen, and argon. Other gases may also be used. Typical gauge pressures for the pressurized gas are 1 to 10 psi (6.9 to 69 kPa). Other gauge pressures may also be used. Respective outlet openings 2036 of jet passages 2052 are helically advanced in the direction of gas stream rotation relative to their inlet openings 2056, although this is not a requirement.

Preferably, the jet passages (which are tubes) have an inner diameter in the range of 0.01 inch (0.25 mm) to 0.05 inch (1.27 mm), although this is not a requirement. Preferably, the jet passages have respective lengths in the range of 0.10 inch (0.25 mm) to 1.00 inch (2.54 cm), although this is not a requirement.

Referring now to FIG. 13, particle inlet 2024 has an annular counterbore 2045 which can receive, e.g., an O-ring seal to prevent particle leakage during operation of powder jet pump 2020 if connected to a particle feed device (e.g., a screw feeder or gravity hopper). Nozzle throat 2040 has a nozzle throat inner wall 2046. Jet passages 2052 are helically configured such that a portion of each jet passage 2052 adjacent to its respective outlet opening 2036 is disposed at an angle of 1 to 10 degrees relative to the nozzle throat inner wall 2046. In this embodiment, the gas stream causes a vortex to form in the nozzle throat, thereby reducing recirculating flow in the gas stream emerging from nozzle. While the above geometry is preferred, other angles of the jet passages relative to the nozzle throat inner wall may also be used.

Nozzle throat 2040 has an inner diameter 2041, and nozzle 2042 has a maximum inner diameter 2043 (see FIGS. 13 and 14). In some embodiments, the ratio of the inner diameter 2041 to the maximum inner diameter 2043 is in the range of 1:1 to 1:20, preferably 1:2 to 1:10, and more preferably 1:4 to 1:7. Preferably, the nozzle throat has a minimum inner diameter 2041 in the range of 0.03 inch (0.76 mm) to 0.11 inch (2.79 mm), although this is not a requirement.

While the powder jet pump can be made from assembled parts, in preferred embodiments, the powder jet pump is unitary (i.e., a single part). This may be accomplished by a rapid prototyping method such as, for example, fused deposition modeling or stereolithography.

The various components of the powder jet pump may be made of any suitable material(s), including, for example, metal, plastic (including engineering plastics such as high density polyethylene, polycarbonate, polyimide, polyether ether ketone, polyether ketone), glass, and fiber reinforced composites, (e.g., fiberglass, carbon fiber composites), and combinations thereof.

Useful substrates are typically suppled in roll form, and may comprises any substantially 2-dimensional web material. Examples include papers (e.g., cellulosic or synthetic fiber-based), polymer films, metal foils, nonwoven fiber webs (e.g., meltspun nonwovens), coated versions thereof, and combinations thereof.

Suitable powders include powders comprising graphite, clays, hexagonal boron nitride, pigments, inorganic oxides (e.g., alumina, calcia, silica, ceria, zinc oxide, or titania), metal(s), organic polymeric particles (e.g., polytetrafluoroethylene, polyvinylidene difluoride), dry biological powders (e.g., spores, bacteria). Graphite powders are particularly preferred. Preferably, the powder comprises mainly unagglomerated/deagglomerated constituent particles when dispensed from the powder coating die.

During powder-rubbing, the powder particles are adhered to the substrate by a frictional shearing mechanism. This process may yield nanoscale film coatings with bulk properties resulting from particle alignment.

### SELECT EMBODIMENTS OF THE PRESENT DISCLOSURE

In a first embodiment, the present disclosure provides a powder-rubbing apparatus suitable for making a powder-rubbed substrate, the powder-rubbing apparatus comprising:

a rotatable rubbing roll having a rotational axis;

a substrate path for conveying the substrate in a machine direction into frictional contact with the rotatable rubbing roll within a rubbing zone, wherein the substrate frictionally contacts the rotatable rubbing roll within the rubbing zone;

an oscillating mechanism for oscillating the rotatable rubbing roll along the rotational axis;

a powder coating die comprising an inlet port in fluid communication with an outlet port, wherein the powder coating die is disposed adjacent to the substrate path; and

a dispenser for dispensing gas-borne powder in fluid communication with the inlet port of the powder coating die, wherein the dispenser is aligned such that at least a portion of a gas-borne powder dispensed from the powder coating die is deposited directly onto at least one of the rotatable rubbing roll or the substrate and conveyed into the rubbing zone.

In a second embodiment, the present disclosure provides a powder-rubbing apparatus according to the first embodiment, the powder coating die is disposed adjacent to the rotatable rubbing roll outside the rubbing zone, and is adapted such that the gas-borne powder dispensed from the powder coating die is carried by the rotatable rubbing roll into the rubbing zone.

In a third embodiment, the present disclosure provides a powder-rubbing apparatus according to the first or second embodiment, wherein the rotatable rubbing roll has an air permeable outer sleeve.

In a fourth embodiment, the present disclosure provides a powder-rubbing apparatus according to any one the first to third embodiments, wherein the outer sleeve comprises at least one of a fabric or a foam.

In a fifth embodiment, the present disclosure provides a powder-rubbing apparatus according to any one the first to fourth embodiments, wherein the rotational axis is parallel to a cross-substrate direction perpendicular to the machine direction.

In a sixth embodiment, the present disclosure provides a powder-rubbing apparatus according to any one the first to fifth embodiments, wherein the dispenser of gas-borne powder is fluidly connected to and downstream from a powder deagglomerator comprising:

a vertical flow chamber having a longitudinal axis and comprising:
an outer wall;
a powder outlet port disposed at an upper end of the vertical flow chamber;
a mounting port sealably engaging an acoustic horn disposed at a lower end of the vertical flow chamber opposite the upper end;

a powder inlet tube aligned to dispense agglomerated powder in a gaseous stream downward onto a distal end of the acoustic horn; and

an acoustic transducer vibrationally coupled to the acoustic (preferably ultrasonic) horn.

In a seventh embodiment, the present disclosure provides a powder-rubbing apparatus according to the sixth embodiment, wherein the powder deagglomerator further comprises a pressure housing secured to the mounting port such that the acoustic horn extends within the pressure housing.

In an eighth embodiment, the present disclosure provides a powder-rubbing apparatus according to the sixth or seventh embodiment, wherein one end of the powder inlet tube is disposed along the longitudinal axis of the vertical flow chamber.

In a ninth embodiment, the present disclosure provides a powder-rubbing apparatus according to any one of the sixth to ninth embodiments, wherein the upper and lower ends of the vertical flow chamber are inwardly tapered toward the longitudinal axis.

In a tenth embodiment, the present disclosure provides a powder-rubbing apparatus according to any one the first to ninth embodiments, wherein the dispenser of gas-borne powder is fluidly connected to, and downstream from, a powder jet pump.

In an eleventh embodiment, the present disclosure provides a powder-rubbing apparatus according to the tenth embodiment, wherein the powder jet pump comprises:

a main body having a particle inlet at a first end and an outlet connector at a second end, the particle inlet being in fluid communication with an inlet chamber;

a nozzle defining a passage in fluid communication with the chamber and outlet connector, wherein the nozzle includes a nozzle throat;

at least one suction inlet in fluid communication with the chamber;

an annular plenum positioned around the main body having a gas inlet; and

at least two jet passages each having an inlet opening into the annular plenum and an outlet opening within the nozzle throat.

In a twelfth embodiment, the present disclosure provides a powder-rubbing apparatus according to the eleventh embodiment, wherein the gas inlet is configured to impart a direction of rotation within the annular plenum to a gas travelling through the gas inlet and into the annular plenum.

In a thirteenth embodiment, the present disclosure provides a powder-rubbing apparatus according to the eleventh or twelfth, wherein respective outlet openings of the at least two jet passages are helically advanced in the direction of rotation relative to their respective inlet openings.

In a fourteenth embodiment, the present disclosure provides a powder-rubbing apparatus according to any one of the eleventh to fourteenth embodiments, wherein the nozzle throat has a nozzle throat inner wall, and wherein the at least two jet passages are configured such that a portion of each jet passage adjacent to its respective outlet opening is disposed at an angle of 1 to 10 degrees relative to the nozzle throat inner wall.

In a fifteenth embodiment, the present disclosure provides a powder-rubbing apparatus according to any one of the eleventh to thirteenth embodiments, wherein the nozzle throat has a longitudinal axis, wherein the at least two jet passages are configured such that a portion of each jet passage adjacent to its respective outlet opening is disposed at an angle of 1 to 10 degrees relative to the longitudinal axis of the nozzle throat.

In a sixteenth embodiment, the present disclosure provides a powder-rubbing apparatus according to any one of the eleventh to fifteenth embodiments, wherein the nozzle throat has an inner diameter, wherein the nozzle has a maximum inner diameter, and wherein the ratio of the inner diameter of the nozzle throat to the maximum inner diameter of the nozzle is in the range of 1:2 to 1:10.

In a seventeenth embodiment, the present disclosure provides a powder-rubbing apparatus according to any one of the eleventh to sixteenth embodiments, wherein the powder jet pump is unitary.

In an eighteenth embodiment, the present disclosure provides a powder-rubbing apparatus according to any one of the eleventh to seventeenth embodiments, wherein the nozzle throat has a minimum inner diameter in the range of 0.03 inch (0.76 mm) to 0.11 inch (2.79 mm).

In a nineteenth embodiment, the present disclosure provides a powder-rubbing apparatus according to any one of the eleventh to eighteenth embodiments, wherein the at least two jet passages have respective inner diameters in the range of 0.01 inch (0.25 mm) to 0.05 inch (1.27 mm).

In a twentieth embodiment, the present disclosure provides a powder-rubbing apparatus according to any one of the eleventh to nineteenth embodiments, wherein the at least two jet passages have respective lengths in the range of 0.10 inch (0.25 mm) to 1.00 inch (2.54 cm).

In a twenty-first embodiment, the present disclosure provides a powder-rubbing apparatus according to any one the first to twentieth embodiments, further comprising a vacuum source adjacent to and in fluid communication with the substrate.

In a twenty-second embodiment, the present disclosure provides a powder-rubbing apparatus according to any one the first to twenty-first embodiments, wherein the vacuum source is disposed downstream of the rubbing zone.

In a twenty-third embodiment, the present disclosure provides a powder-rubbing apparatus according to the twenty-second embodiment, wherein the vacuum source is proximate to the powder coating die.

In a twenty-fourth embodiment, the present disclosure provides providing a method of making a powder-rubbed substrate, the method comprising:

providing a powder-rubbing apparatus according to any one of the first to twenty-third embodiments, wherein the rotatable rubbing roll is rotating, and wherein the rotatable rubbing roll is oscillating along its rotational axis;

disposing a substrate along the substrate path;

advancing the substrate in the machine direction at a differential rate relative to the rotatable rubbing roll; and

delivering the gas-borne powder from the outlet port onto at least one of the rotatable rubbing roll or the substrate, wherein at least some of the powder is rubbed onto the substrate as the substrate and the rotatable rubbing roll contact each other, thereby providing the powder-rubbed substrate.

In a twenty-fifth embodiment, the present disclosure provides a method according to the twenty-fourth embodiment, wherein the outlet port of the powder coating die is spaced a distance of 300 mils (7.6 mm) or less from the rotatable rubbing roll.

In a twenty-sixth embodiment, the present disclosure provides a method according to the twenty-fourth or twenty-fifth embodiment, wherein the substrate comprises at least one of a polymer film, a nonwoven fiber web, paper web, and a metal foil.

In a twenty-seventh embodiment, the present disclosure provides a method according to any one of the twenty-fourth to twenty-sixth embodiments, wherein the powder comprises graphite.

In a twenty-eighth embodiment, the present disclosure provides a powder-rubbed web comprising a substrate having a powder-rubbed layer on a major surface thereof, wherein the powder-rubbed layer comprises at least one oscillatory rubbing track.

In a twenty-ninth embodiment, the present disclosure provides a powder-rubbed web according to the twenty-eighth embodiment, wherein the powder-rubbed layer comprises graphite.

In a thirtieth embodiment, the present disclosure provides a powder-rubbed web according to the twenty-eighth or twenty-ninth embodiment, wherein the substrate comprises a polymer film.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Comparative Example A

A 0.5-mil (13-micrometer) thick polyethylene terephthalate (PET) web was powder-rub coated to approximately 12 inches (30.5 cm) wide with graphite (Asbury M850, Asbury Carbons, Asbury, N.J.) using a nylon fiber paint pad (20 denier (22 decitex)×0.180-inch (4.6 mm) fibers on a 3/16-inch (4.8 mm) thick green polyester foam backing (from Padco Inc, Minneapolis, Minn.) adhered to the surface of a 10-inch (25.4 cm) diameter applicator roll. The web was guided into contact with the pad by idler rollers positioned adjacent to the applicator roll, yielding a web wrap of approximately 67% of the applicator roll circumference. Graphite was metered at rate of 0.2 gram/minute (g/min) from a screw feeder (Brabender MiniTwin, Brabender Technologie KG, Duisberg, Germany) into a jet pump (as shown in FIGS. 12-15, nozzle throat inner diameter=0.08 inch (2.0 mm), jet passage inner diameter=0.03 inch (0.8 mm), jet passage length=1.0 inch (2.54 cm)) that dispersed particles into an air stream (flow rate=8.3 L/min). The particle dispersion was conveyed through polyethylene tubing into a coating die that spread the air flow and entrained graphite particles to distribute along the width of the pad.

The applicator roll and coating die were housed within an enclosure (similar to FIG. 2) where suction was applied from a vacuum source in order to maintain negative pressure (less than ambient pressure) around the coating process. The vacuum port was positioned adjacent to the location where the web exited from the enclosure.

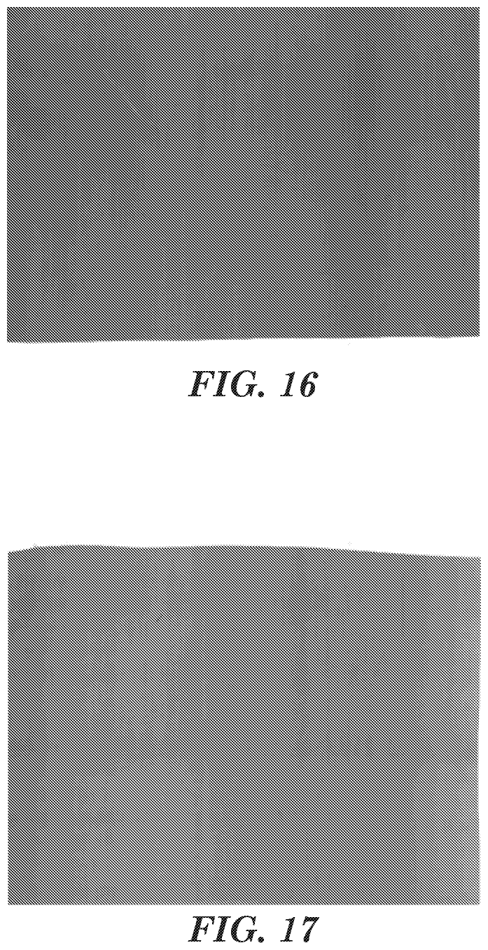

Web tension was applied at 1 pound per lineal inch (ph) (0.18 kg/cm) and web speed was set at 5 feet per minute (fpm) (1.5 m/min). The applicator roll was rotated at a surface speed of 505 feet per minute (154 m/min). These process conditions yielded a graphite coating on the PET web. The resulting coating shown in FIG. 16 had a non-uniform appearance due to many thin, dark streaks that were located at intervals across the width of the web.

### Example 1

A 0.5-mil (13-micrometer) thick PET web was powder-rubbed with graphite using a nylon fiber paint pad following the procedure in Comparative Example A, except that the applicator roll was rotated at a surface speed of 505 feet per minute (154 m/min) while being oscillated in the transverse direction at 10.3 Hz frequency and 5 millimeters amplitude in displacement. These process conditions yielded a graphite coating on the PET web that had substantially improved uniformity relative to samples generated with the procedure of Comparative Example A, and which is shown in FIG. 17.

### Comparative Example B

A 0.5-mil (13-micrometer) thick PET web was powder-rub coated to approximately 9-inch (23-cm) width using the materials and method described in Comparative Example A. Graphite was metered at rate of 0.2 gram/minute (g/min) into a jet pump (as shown in FIGS. 12-15, nozzle throat inner diameter=0.08 inch (2.0 mm), jet passage inner diameter=0.02 inch (0.5 mm), jet passage length=0.55 inch (1.4 cm)) that dispersed particles into an air stream (flow rate=5.4 L/min). The particle dispersion was conveyed into a coating die that spread the air flow and entrained graphite particles to distribute along the width of the coating pad.

Web tension was applied at 1 pli (0.18 kg/cm) and web speed was set at 10 fpm (3.0 m/min). The applicator roll was rotated at a surface speed of 210 fpm (64 m/min). These process conditions yielded a graphite coating on the PET web. The resulting coating was electrically conductive as indicated by surface resistivity values measured with a digital multimeter (Keysight 34461A Digital Multimeter, Santa Rosa, Calif.). Surface resistivity data were collected at 1-inch (2.54 cm) intervals along a line across the width of the coating, as shown in Table 1.

### Example 2

A 0.5-mil (13-micrometer) thick PET web was powder-rub coated with graphite following the procedure described in Comparative Example B, except that the applicator roll was rotated at a surface speed of 210 fpm (64 m/min) while being oscillated in the transverse direction at 10.3 Hz frequency and 5 millimeters amplitude in displacement. These process conditions yielded a graphite coating on the PET web and surface resistivity measurements were made using the same procedure described in Comparative Example B. The surface resistivity data reflect an improvement in coating conductivity (reduction in local and average surface resistivity) relative to the sample generated with the procedure of Comparative Example B, as reported in Table 1, below.

TABLE 1

| | | | | | | | | | | Standard |
|---|---|---|---|---|---|---|---|---|---|---|
| | | | | | | | | | Average, | Deviation, |
| | Surface Resistivity Values | | | | | | | | kOhm/ | kOhm/ |
| | (kOhm/square) | | | | | | | | square | square |
| Compara- | 30 | 36 | 27 | 27 | 33 | 38 | 45 | 50 | 36 | 8 |
| tive Ex- | | | | | | | | | | |
| ample B | | | | | | | | | | |
| Example 2 | 19 | 21 | 15 | 18 | 20 | 17 | 9 | 10 | 16 | 4 |

### Comparative Example C

A 0.5 mil (13 micrometer) thick PET web was powder-rub coated with graphite using the materials and method described in Comparative Example B, except that a piece of adhesive tape of 0.25-inch (6 mm) width was located at the exit of the die slot at a distance of 1 inch (2.54 cm) from the center along the slot width. The resulting graphite coating on PET web presented a streak defect that appeared as a reduction of coating corresponding to the location and width of the tape. In order to quantify the variation in coating intensity in the streak defect, the sample was digitally scanned (HP LaserJet M5035 MFP, Hewlett-Packard) and pixel gray values were measured across the width of the coating using ImageJ 1.48v image processing software (from the National Institutes of Health, Bethesda, Md., downloaded from the worldwide web at https://imagej.nih.gov/ij). Pixel value measurements showed the streak to have a 7% difference in gray intensity relative to the center of the coating, as reported in Table 2.

### Example 3

A 0.5 mil (13 micrometer) thick PET web was powder-rub coated with graphite following the procedure described in Comparative Example C, except that the applicator roll was rotated at a surface speed of 210 fpm (64 m/min) while being oscillated in the transverse direction at 10.3 Hz frequency and 5 millimeters amplitude in displacement. Relative to Comparative Example C, the roll oscillation improved graphite deposition in the region influenced by the tape obstruction on the die slot. Coating intensity was related to pixel gray values from a digital scan of the coated sample, following the procedure described in Comparative Example C. Pixel value measurements showed the streak to have only a 3% difference in gray intensity relative to the center of the coating, which represented a significant improvement over the streak defect observed in Comparative Example C. Results are reported in Table 2, below.

TABLE 2

| | PIXEL GRAY VALUES | | |
|---|---|---|---|
| | CENTER OF | STREAK | % DIFFERENCE |
| | COATING | DEFECT | IN STREAK |
| Comparative | 148 | 159 | 7% |
| Example C | | | |
| Example 3 | 149 | 153 | 3% |

### Example 4

A 0.5 mil (13 micrometer) thick polyethylene terephthalate (PET) web was powder-rub coated to approximately 8 inches (20.3 cm) width with graphite (Timrex HSAG300, Imerys, Switzerland) using a nylon fiber paint pad (3 denier (3.3 decitex)×0.050-inch (1.27 mm) fibers on 1/16-inch (1.6-mm) thick PVC foam backing (Padco Inc, Minneapolis, Minn.) adhered to the surface of a 10-inch diameter applicator roll. The web was guided into contact with the pad by idler rollers positioned adjacent to the applicator roll, yielding a web wrap of approximately 67% of the applicator roll circumference. Graphite was metered at rate of 0.6 g/min from a screw feeder (Brabender MiniTwin, Brabender Technologie KG, Duisberg, Germany) into a jet pump (similar to that shown in FIGS. 12-15, nozzle throat inner diameter=0.08 inch (2.0 mm), jet passage inner diameter=0.02 inch (0.5 mm), jet passage length=0.55 inch (1.4 cm)) that dispersed particles into an air stream (flow rate=8.4 L/min). The particle dispersion was conveyed through polyethylene tubing into a coating die that spread the air flow and entrained graphite particles to distribute along the width of the pad.

The applicator roll and coating die were housed within an enclosure (similar to FIG. 2) where suction was applied from a vacuum source in order to maintain negative pressure (less than ambient pressure) around the coating process. The vacuum port was positioned adjacent to the location where the web exited from the enclosure. Web tension was applied at 1 pound per lineal inch (pli) (0.18 kg/cm) and web speed was set at 5 feet per minute (1.5 m/min). The applicator roll was rotated at a surface speed of 105 feet per minute (32 m/min), while being oscillated in the transverse direction at 10.3 Hz frequency and 5 mm amplitude in displacement. These process conditions yielded a graphite coating on the PET web with a transient region of heavy graphite deposition at the center of the coating. The transient graphite deposition presented an oscillatory track on the coated sample with peak-to-peak distance comparable to the roller oscillation amplitude (approximately 5 mm) and wavelength (approximately 5 cm) consistent with the roller rotational speed divided by oscillation frequency.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A powder-rubbing apparatus suitable for making a powder-rubbed substrate, the powder-rubbing apparatus comprising:
a rotatable rubbing roll having a rotational axis;
a substrate path for conveying the substrate in a machine direction into frictional contact with the rotatable rubbing roll within a rubbing zone, wherein the substrate frictionally contacts the rotatable rubbing roll within the rubbing zone;
an oscillating mechanism for oscillating the rotatable rubbing roll along the rotational axis;
a powder coating die comprising an inlet port in fluid communication with an outlet port, wherein the powder coating die is disposed adjacent to the substrate path; and
a dispenser for dispensing gas-borne powder in fluid communication with the inlet port of the powder coating die, wherein the dispenser is aligned such that at least a portion of a gas-borne powder dispensed from the powder coating die is deposited directly onto at least one of the rotatable rubbing roll or the substrate and conveyed into the rubbing zone.

2. The powder-rubbing apparatus of claim 1, wherein the powder coating die is disposed adjacent to the rotatable rubbing roll outside the rubbing zone, and is adapted such that the gas-borne powder dispensed from the powder coating die is carried by the rotatable rubbing roll into the rubbing zone.

3. The powder-rubbing apparatus of claim 1, wherein the rotatable rubbing roll has an air permeable outer sleeve.

4. The powder-rubbing apparatus of claim 3, wherein the outer sleeve comprises at least one of a fabric or a foam.

5. The powder-rubbing apparatus of claim 1, wherein the rotational axis is parallel to a cross-substrate direction perpendicular to the machine direction.

6. The powder-rubbing apparatus of claim 1, wherein the dispenser for dispensing gas-borne powder comprises an ultrasonic horn.

7. The powder-rubbing apparatus of claim 1, wherein the dispenser for dispensing gas-borne powder comprises a powder jet pump comprising:
a main body having a particle inlet at a first end and an outlet connector at a second end, the particle inlet being in fluid communication with an inlet chamber;
a nozzle defining a passage in fluid communication with the chamber and outlet connector, wherein the nozzle includes a nozzle throat;
at least one suction inlet in fluid communication with the chamber;
an annular plenum positioned around the main body having a gas inlet; and
at least two jet passages each having an inlet opening into the annular plenum and an outlet opening within the nozzle throat.

8. The powder-rubbing apparatus of claim 1, further comprising a vacuum source adjacent to and in fluid communication with the substrate.

9. The powder-rubbing apparatus of claim 8, wherein the vacuum source is disposed downstream of the rubbing zone.

10. The powder-rubbing apparatus of claim 8, wherein the vacuum source is proximate to the powder coating die.

11. A method of making a powder-rubbed substrate, the method comprising:
providing a powder-rubbing apparatus according to claim 1, wherein the rotatable rubbing roll is rotating, and wherein the rotatable rubbing roll is oscillating along its rotational axis;
disposing a substrate along the substrate path;
advancing the substrate in the machine direction at a differential rate relative to the rotatable rubbing roll; and
delivering the gas-borne powder from the outlet port onto at least one of the rotatable rubbing roll or the substrate, wherein at least some of the powder is rubbed onto the substrate as the substrate and the rotatable rubbing roll contact each other, thereby providing the powder-rubbed substrate.

12. The method of claim 11, wherein the outlet port of the powder coating die is spaced a distance of 300 mils or less from the rotatable rubbing roll.

13. The method of claim 11, wherein the substrate comprises at least one of a polymer film, a nonwoven fiber web, paper web, and a metal foil.

14. The method of claim 11, wherein the powder comprises graphite.

15-17. (canceled)
